(19) United States
(12) Patent Application Publication
(10) Pub. No.: US 2007/0047916 A1
(43) Pub. Date: Mar. 1, 2007

(54) Portable audio/video player having separated video unit and reproduction method thereof

(75) Inventor: Hee-soo Lee, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/496,509

(22) Filed: Aug. 1, 2006

(30) Foreign Application Priority Data
Aug. 31, 2005 (KR) 2005-80790

(51) Int. Cl. H04N 7/00

(52) U.S. Cl. 386/96

(57) ABSTRACT

A portable AV player having a video unit detachably connected to a main body and has a display screen to display video, and a reproduction method thereof. The portable AV player includes a main body to reproduce audio data generated by decoding a stored compressed file, and a video unit detachably connected to the main body and displays video data generated by decoding the compressed file when combined with the main body. Accordingly, since a device size can be minimized whenever a user desires, portability can be increased, and unnecessary power consumption can be avoided.

### CROSS-REFERENCE TO RELATED APPLICATIONS

This application claims the benefit of Korean Patent Application No. 10-2005-0080790, filed on Aug. 31, 2005, in the Korean Intellectual Property Office, the disclosure of which is incorporated herein in its entirety by reference.

### BACKGROUND OF THE INVENTION

1. Field of the Invention

The present general inventive concept relates to a portable audio/video (AV) player and a reproduction method thereof, and more particularly, to a portable AV player having a video unit which can be separated from a main body and has a display screen to display video, and a reproduction method thereof.

2. Description of the Related Art

Portable AV players have the capability to reproduce multimedia content and show color images. Examples are personal media players (PMPs), personal video recorders (PVRs), and portable media centers (PMCs). Compared to this, portable audio players reproduce compressed audio files, such as MP3 files, and audio compact discs (CDs). Recently, flash memory and hard disk drives (HDDs) have typically been used as a storage medium in these devices.

FIG. 1 illustrates a conventional portable audio player 10 and a conventional portable AV player 20.

Referring to FIG. 1, the conventional portable audio player 10 includes an operational key 16 through which user operational commands are transferred, and a display screen 12 through which a file to be reproduced is selected and reproduction information is displayed. In general, a liquid crystal display (LCD), which is less than 2 inches, is used for the display screen 12 to reduce an overall size of the portable audio player 10. In addition, audio files shared over the Web can be downloaded via a personal computer (PC) and reproduced using the portable audio player 10.

The portable audio player 10 downloads audio files shared over the Web or compressed audio files (MP3, WMA, and the like) stored in a PC through a connection to the PC via a universal serial bus (USB) port 14. The portable audio player 10 displays an audio file list on the display screen 12. When a user selects an audio file to be reproduced, using the operational key 16, the portable audio player 10 reproduces the selected file and outputs an audio signal of the selected file to headphones or a speaker via an output terminal (not shown). A reproduction status of the audio file being reproduced by the portable audio player 10 and information related to the audio file are displayed on the display screen 12. When the user stops the reproduction, the portable audio player 10 again displays the audio file list on the display screen 12. If the portable audio player 10 supports a lyrics function, the portable audio player 10 may sequentially display the lyrics of the audio file being reproduced, on the display screen 12.

The conventional portable AV player 20 reproduces a compressed AV file, such as a DIVX or WMV file, and since more than one movie is usually stored in the portable AV player 20, an HDD having more than 1 GB memory space is typically used as a storage medium.

The portable AV player 20 includes a plurality of operational keys 25a, 25b, and 25c used by a user to input information, and a display screen 22 for displaying a menu of AV files and video being reproduced. The display screen 22 typically employs an LCD of more than 3 inches to use a minimum amount of video resolution.

The portable AV player 20 downloads compressed AV files (e.g., DIVX, WMW, and MPEG) shared or sold over the Web through a connection to a PC via a USB port 24, and displays an AV file list on the display screen 22. When the user selects a desired AV file using the operational keys 25a, 25b, and 25c, the portable AV player 20 reproduces the selected file and displays it on the display screen 22. Here, an audio signal is output to headphones or a speaker via an output terminal (not shown), and a reproduction status of the AV file being reproduced by the portable AV player 20 and information related to the AV file may be displayed on the display screen 22. When the user stops the reproduction, the portable AV player 20 again displays the AV file list on the display screen 22. When the portable AV player 20 reproduces an audio file, the portable AV player 20 operates in the same manner as the portable audio player 10.

However, most portable audio players which have been put on the market can reproduce only compressed audio files. Even if some portable audio players can display JPEG still images, a size of their display screen is not large enough, thereby making image perception difficult. In addition, although most portable AV players have a video file reproduction function and an audio (MP3 or similar) reproduction function, users typically use the portable AV players for audio file reproduction rather than video file reproduction.

Thus, if the portable AV players having increased size and weight due to an increase of the size of a display screen are used only for audio file reproduction, their portability is not fully utilized. In addition, driving a large sized display screen increases power consumption and reduces battery life.

### SUMMARY OF THE INVENTION

The present general inventive concept provides a portable AV player having a video unit which can be separated from a main body and has a display screen to display video, and a reproduction method thereof.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a portable audio/video (AV) player, including a main body to reproduce audio data generated by decoding a stored compressed file, and a video unit detachably connected to the main body to display video data generated by decoding the compressed file when combined with the main body.

The audio data and video data may be generated by decoding the compressed file in the main body. The audio data may be generated by decoding the compressed file in the main body, and the video data may be generated by decoding the compressed file in the video unit. The portable AV player may further include at least one storage medium disposed in at least one of the main body and the video unit to store the compressed file.

The foregoing and/or other aspects of the present general inventive concept may also be achieved by providing a portable audio/video (AV) player, including a main body having a storage medium, an AV codec unit to generate video and audio data by decoding a compressed file stored in the storage medium, an audio processing unit to reproduce the audio data, and a controller to control the AV codec unit and the audio processing unit, and a video unit detachably connected to the main body and displays the video data transmitted from the main body when combined with the main body.

The foregoing and/or other aspects of the present general inventive concept may also be achieved by providing a portable audio/video (AV) player including a main body, and a video unit to transmit and receive signals to and from the main body when the video unit is combined with the main body. The video unit includes a video decoder to generate video data by decoding a stored compressed file, a second display unit, and a display controller to control the second display unit to display the video data. The main body includes an audio codec unit to generate audio data by decoding an audio portion of the compressed file, an audio processing unit to reproduce the audio data, and a controller to control the audio codec unit and the audio processing unit according to operational commands of a user.

The foregoing and/or other aspects of the present general inventive concept may also be achieved by providing a portable A/V player, including a main body including an interface mounted in the main body to be connectable to an external network, a unit disposed in the main body to process a signal received through the interface to generate audio data and video data, a terminal mounted in the main body to reproduce the audio data, a display mounted in the main body, and a connector mounted in the main body. The video data is selectively output through the display unit and the connector.

The foregoing and/or other aspects of the present general inventive concept may also be achieved by providing a portable AV player, including a first unit to output an audio signal, a second unit to output a video signal, and a connector to detachably connect the first and second units and having first and second connecting parts disposed in the first and second units, respectively, that form an insertable card type connection such that signals are transmitted between the first and second units.

The foregoing and/or other aspects of the present general inventive concept may also be achieved by providing a portable AV player, including an audio output unit to output sound, a video output unit to display video, a connector to detachably connect the audio and video output units, and a controller disposed in one of the audio and video output units to detect a connection state of the connector with respect to the audio and video output units and to operate the one of the audio and video output units based on the detected connection state.

The foregoing and/or other aspects of the present general inventive concept may also be achieved by providing a portable AV player, including a first unit to generate first and second portions of a multimedia file and to output the first portion of the multimedia file, and a second unit detachably connected to the first unit to receive and output the second portion of the multimedia file when the second unit is connected to the first unit.

The foregoing and/or other aspects of the present general inventive concept may also be achieved by providing a reproduction method in a portable audio/video (AV) player having a main body and a video unit detachably connected to the main body, the method including reproducing, using the main body, audio data generated by decoding a stored compressed file, receiving, in the video unit, video data generated by decoding the compressed file from the main body, and displaying the video data using the video unit.

The foregoing and/or other aspects of the present general inventive concept may also be achieved by providing a reproduction method in a portable audio/video (AV) player having a main body and a video unit detachably connected to the main body, the method including displaying, using the video unit, video data generated by decoding a stored compressed file, and reproducing, using the main body, audio data generated by receiving and decoding the compressed file from the video unit.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates a conventional portable audio player and a conventional portable AV player;

FIGS. 2 and 3 are perspective views illustrating a portable AV player according to an embodiment of the present general inventive concept;

FIG. 4 is a block diagram illustrating a portable AV player according to an embodiment of the present general inventive concept;

FIGS. 5 and 6 are flowcharts illustrating operation of the portable AV player of FIG. 4, according to an embodiment of the present general inventive concept; and

FIG. 7 is a block diagram illustrating a portable AV player according to another embodiment of the present general inventive concept.

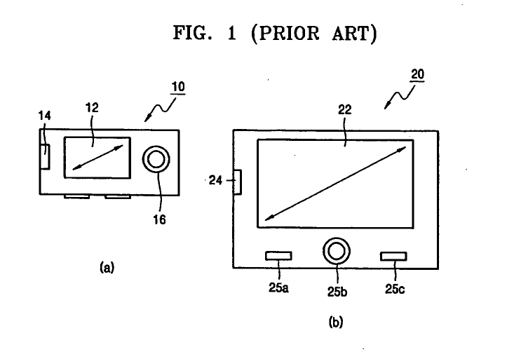

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

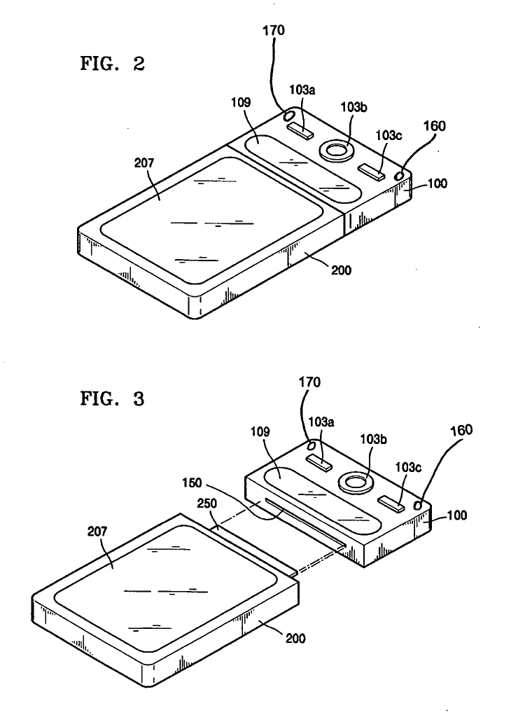

FIGS. 2 and 3 are perspective views illustrating a portable AV player according to an embodiment of the present general inventive concept. Referring to FIGS. 2 and 3, the portable AV player includes a main body 100 and a video unit 200 which can be separated from the main body 100. The main body 100 and the video unit 200 are combined using connectors 150 and 250 to be removably coupled to each other. When the main body 100 and the video unit 200 are combined, the main body 100 and the video unit 200 can transmit and receive signals between each other. The main body 100 includes a first display unit 109, and the video unit 200 includes a second display unit 207. LCD panels can be used for display screens of the first and second display units 109 and 207. The second display unit 207 has a larger display screen than the first display unit 109. It is possible that the video unit 200 is larger than the main body 100 in size. The connectors 150 and 250 may be an insertable card type connector. For example, the connector 250 may be an insertion part having one or more first connections and the connector 150 may be a slot part in which the connector 250 is insertable and having one or more second connections to contact the first connections.

The main body 100 further includes operational keys 103a, 103b, and 103c to receive an operational command of a user, and all operations of the portable AV player can be controlled using the operational keys 103a, 103b, and 103c according to operational commands of the user. The main body 100 may further include an interface 170 that is connectable to an external network to receive a signal corresponding to a file having an audio signal or audio and video signals in a compressed form. The main body 100 can be configured to perform encoding and decoding of an audio signal only or encoding and decoding of both the audio signal and a video signal. Likewise, the video unit 200 can be configured to display only video corresponding to the video signal transmitted from the main body 100 or also display video by decoding the video signal stored therein. The main body 100 may independently operate without a connection with the video unit 200, and the main body 100 may have an audio terminal 160 through which the audio signal is produced and to which an earphone, headphone, or speakers are connected.

The portable AV player consumes a minimum amount of power, since the main body 100 can be used to reproduce an audio signal without operation of the video unit 200. In other words, only components in the main body 100 are driven to reproduce the audio signal. Additionally, the portable AV player can be converted between a first configuration (i.e., the main body 100 is combined with the video unit 200) to reproduce the video signal and the audio signal together through the second display unit 207 and the audio terminal 160, respectively, and a second configuration (i.e., the main body 100 is separated from the video unit 200) to reproduce only the audio signal, thereby maximizing a portability of the AV player. The portable AV player may be connected in a third configuration to produce the video signal on the first display unit 109 and the audio signal through a speaker or earphones.

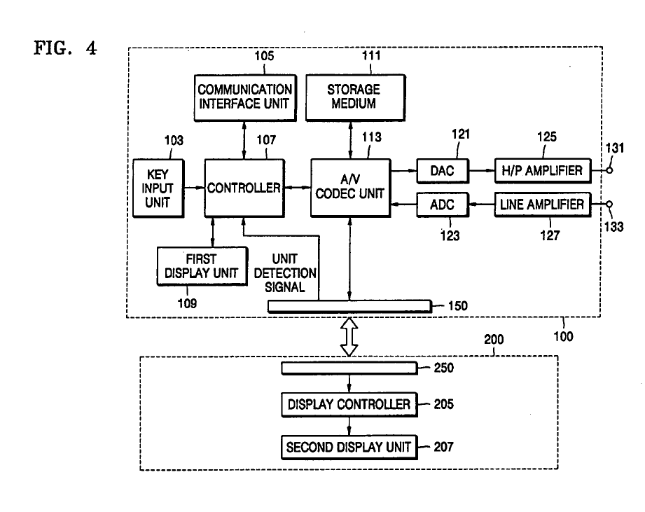

FIG. 4 is a block diagram illustrating a portable AV player according to an embodiment of the present general inventive concept. The portable AV player of FIG. 4 may be similar to the portable AV player of FIGS. 2 and 3. Accordingly, for illustration purposes, the portable AV player of FIG. 4 is described below with reference to FIGS. 2 and 3. Referring to FIG. 4, the portable AV player includes the main body 100 and the video unit 200 such that the main body 100 and the video unit 200 can transmit and receive signals therebetween when combined using the connectors 150 and 250.

The main body 100 includes a user interface to input the operational commands of a user (e.g., the operation keys 103a, 103b, and 103c). The main body 100 may be a processing unit, a main processing unit, a first processing unit, an audio unit, a primary processing unit, or a first output unit and performs general system control, audio encoding and decoding, and video decoding. The video unit 200 displays video data input from the main body 100 via the connectors 150 and 250 on the second display unit 207. The video unit 200 may be a video processing unit, a second processing unit, an auxiliary processing unit, a secondary processing unit, or a second output unit.

The main body 100 includes a key input unit 103, a communication interface unit 105, a controller 107, the first display unit 109, a storage medium 111, an AV codec unit 113, a digital-to-analog converter (DAC) 121, an H/P (headphone) amplifier 125, an analog-to-digital converter (ADC) 123, and a line amplifier 127. The DAC 121 and the H/P amplifier 125 play together may be an audio processing unit.

The key input unit 103 has a plurality of operational keys (e.g., the operational keys 103a, 103b, and 103c) and transmits key signals corresponding to the operational commands of the user to the controller 107. The communication interface unit 105 provides an interface to download or upload data from or to a PC. A Universal Serial Bus (USB), which is a plug and play interface between the PC and a peripheral, is a representative communication interface provided by the communication interface unit 105. However, it should be understood that the present general inventive concept is not limited to this, and the communication interface unit 105 can use other various communication interface protocols, devices, and methods which allow data communication with an external device.

The controller 107 controls the operation of all components including the AV codec unit 113. The controller 107 determines a signal path according to an operation mode.

The first display unit 109 displays information and a reproduction status of an audio file in an audio reproduction mode, and the storage medium 111 stores AV data or a file of compressed audio data.

The controller 107 can control the AV codec unit 113 to generate video and audio data by decoding a compressed AV file stored in the storage medium 111. The audio data generated by the AV codec unit 113 is processed by the DAC 121 and the H/P amplifier 125 (i.e., the audio processing unit). That is, the DAC 121 converts the audio data output from the AV codec unit 113 to an analog signal, and the H/P amplifier 125 amplifies the analog signal output from the DAC 121 and outputs the amplified analog signal to an output terminal 131.

In addition, the AV codec unit 113 can encode an audio signal input from an external device and stores the encoded audio signal in the storage medium 111 as a compressed AV file. That is, the audio signal input via an input terminal 133 is amplified by the line amplifier 127, converted to digital data by the ADC 123, compressed by the AV codec unit 113, and stored in the storage medium 111.

The video unit 200 includes a display controller 205 and the second display unit 207. When the video unit 200 is combined with the main body 100, the display controller 205 displays the video data decoded by the AV codec unit 113 on the second display unit 207. The second display unit 207 may display a system control status and a video signal.

The main body 100 can supply power to operate the video unit 200, or the video unit 200 can include its own power supply. The connection of the video unit 200 with the main body 100 can be detected by checking whether a unit detection signal mechanically or electrically generated using the connectors 150 and 250 is transmitted to the controller 107.

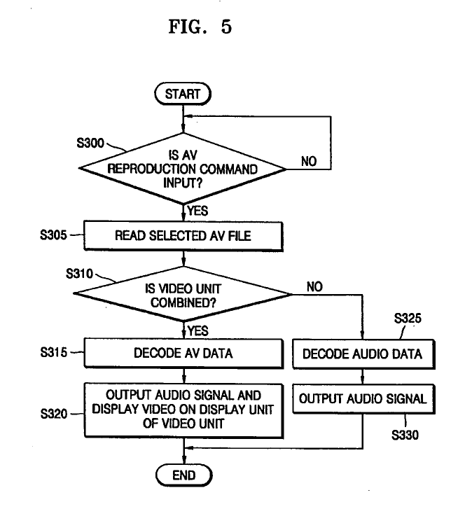

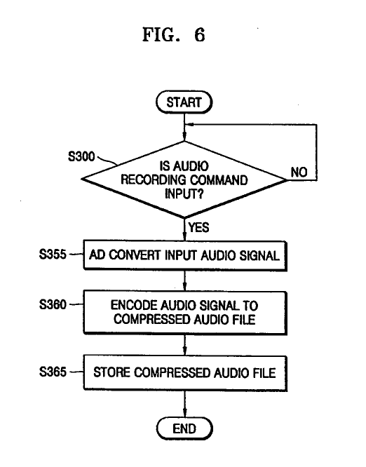

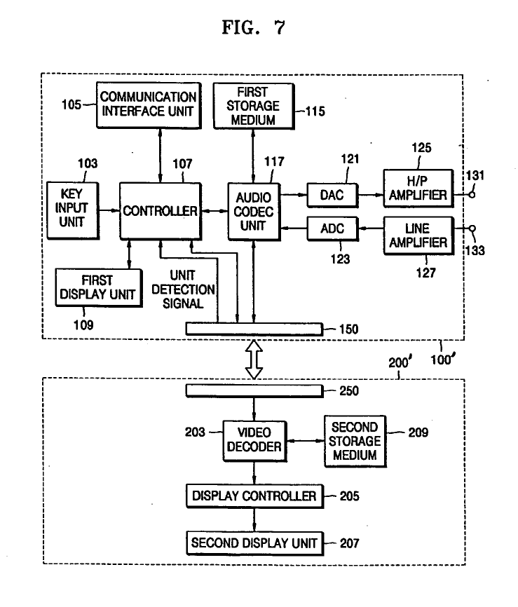

FIGS. 5 and 6 are flowcharts illustrating operation of a portable AV player according to an embodiment of the present general inventive concept. The operation of FIGS. 5 and 6 can be performed by the portable AV player of FIGS. 2 to 4. Accordingly, for illustration purposes, the operation of FIGS. 5 and 6 are described below with reference to FIGS. 2 to 4. FIG. 5 illustrates the operation of the portable AV player when an AV reproduction command to reproduce a stored AV compression file is input (e.g., via the key input unit 103), and FIG. 6 illustrates the operation of the portable AV player when an audio recording command to record an audio signal input from an external device is input.

Referring to FIGS. 4 and 5, in operation S300, the controller 107 determines whether a key signal corresponding to the AV reproduction command is input via the key input unit 103. Here, it is assumed that the user has selected the stored AV compression file (e.g., from among compression files stored in the storage medium 111) using the user interface. If the key signal corresponding to the AV reproduction command is input, the controller 107 controls the AV codec unit 113 to read the selected AV file from the storage medium 111 in operation S305.

When the AV file is read, the AV codec unit 113 determines whether the video unit 200 is combined with the main body 100 in operation S310. The connection of the video unit 200 with the main body 100 can be detected by checking whether the unit detection signal mechanically or electrically generated using the connectors 150 and 250 is transmitted to the controller 107, and the controller 107 transmits the unit detection signal to the AV codec unit 113. Accordingly, the AV codec unit 113 determines whether the video unit 200 is connected to the main body 100 based on the unit detection signal received from the controller 107.

If the video unit 200 is determined to be combined with the main body 100, in operation S315, the AV codec unit 113 decodes the AV file and then outputs the corresponding audio data to the DAC 121 and video data to the video unit 200 via the connectors 150 and 250. In operation S320, the corresponding audio signal is output to the output terminal 131 via the DAC 121 and the H/P amplifier 125 (i.e., the audio processing unit), and the display controller 205 of the video unit 200 controls the second display unit 207 to display the corresponding video data.

When the video unit 200 is combined with the main body 100, the user interface may be provided through the second display unit 207, since the second display unit 207 is larger than the first display unit 109. In this case, the first display unit 109 can be turned off. Alternatively, the user interface can be provided through the first display unit 109.

If the video unit 200 is determined not to be combined with the main body 100 in the operation S310, the AV codec unit 113 decodes only an audio portion of the AV compression file in operation S325, and outputs the decoded audio signal to the DAC 121 in operation S330. The audio signal is converted to a digital signal by the DAC 121, is amplified by the H/P amplifier 125, and is output through the output terminal 131. Accordingly, the audio signal is played through headphones, earphones, or speakers connected to the output terminal 131. When the video unit 200 is separated from the main body 100, the user interface for the operation can be provided through the first display unit 109. By the process described above, the operation corresponding to the AV reproduction command input by the user is performed.

FIG. 6 illustrates the operation of the portable AV player when the audio recording command is input by the user. Referring to FIGS. 4 and 6, in an audio recording mode, a key signal corresponding to the audio recording command is input through the key input unit 103. Then, an analog audio signal input through the input terminal 133 is amplified by the line amplifier 127, converted to a corresponding digital signal by the ADC 123 in operation S355, and encoded to a corresponding compressed audio file by the AV codec unit 113 in operation S360. The compressed audio file is stored in the storage medium 111 in operation S365.

Although the portable AV player operates regardless of whether the video unit 200 is combined with the main body 100 in the recording mode of an audio file, when the video unit 200 is combined with the main body 100, the user interface may be provided through the second display unit 207, since the second display unit 207 is larger than the first display unit 109. Accordingly, the first display unit 109 can be turned off.

FIG. 7 is a block diagram illustrating a portable AV player according to another embodiment of the present general inventive concept. Referring to FIG. 7, the portable AV player includes a main body 100′ in which audio data is decoded and a video unit 200′ in which video data is decoded. Other components, functions, operations, and configurations are similar to those of previous embodiments described above. These similar components are represented by the same reference numbers.

The function and operation of the key input unit 103, the communication interface unit 105, the controller 107, the first display unit 109, a first storage medium 115 (similar to the storage medium 111 of FIG. 4), the DAC 121, the H/P amplifier 125, the ADC 123, and the line amplifier 127 included in the main body 100′ are similar to those described with reference to FIG. 4. However, in the present embodiment, since the main body 100′ may decode only the audio data, an audio codec unit 117 is included in the main body 100′. Similarly, the video unit 200 includes a video decoder 203 and a second storage medium 209.

The audio codec unit 117 decodes a compressed audio file stored in the first storage medium 115, or encodes an analog audio signal input through the line amplifier 127 and the ADC 123 from an external device and stores the encoded audio signal in the first storage medium 115.

The video decoder 203 decodes a compressed AV file stored in the second storage medium 209 so that the display controller 205 controls the second display unit 207 to display the decoded video, and transmits an audio portion of the stored AV file to the audio codec unit 117 so that the audio codec unit 117 decodes the audio portion. A flash memory may be used as the first storage medium 115 to store the audio files, and a bulk storage medium, such as an HDD, may be used as the second storage medium 209 to store the AV files.

Operation of the portable AV player of the present embodiment is similar as the operation described with reference to FIG. 4. However, when the AV reproduction command to perform video encoding in the video unit 200′ is input, the video decoder 203 reads an AV file selected according to the AV reproduction command from the second storage medium 209 and decodes the selected AV file. That is, the video decoder 203 decodes a video file and transmits a corresponding audio file to the audio codec unit 117. The audio file is decoded by the audio codec unit 117 and output to the output terminal 131 through the DAC 121 and the H/P amplifier 125.

As described above, when the video unit 200′ is combined with the main body 100′, the user interface can be provided through the second display unit 207 and the first display unit 109 can be turned off.

When an audio recording command is input, an analog audio signal input through the input terminal 133 is amplified by the line amplifier 127, converted to a corresponding digital signal by the ADC 123, encoded to a corresponding compressed audio file by the audio codec unit 117, and stored in the first storage medium 115. Here, if necessary, the portable AV player can be configured to store the compressed audio file in the second storage medium 209. For example, if the audio file is part of an AV file, the AV file can be stored in the second storage medium 209.

According to the above configuration, since the video unit 200 decodes the video data, the configuration of the main body 100′ can be simpler than the main body 100 in the embodiment of FIG. 4, thereby increasing a portability of the main body 100′ when the video unit 200′ is separated from the main body 100′.

In the embodiments of the present general inventive concept, the main body 100 or 100′ can be a processing unit, a primary processing unit, an audio unit, a first processing unit, a main processing unit, a first casing, a first output unit, etc., while the video unit 200 or 200′ can be an auxiliary processing unit, a secondary processing unit, a second processing unit, a second casing, a second output unit, etc. Additionally, the main body 100 or 100′ and the video unit 200 or 200′ may collectively constitute a combination/combinable body.

As described above, according to embodiments of the present general inventive concept, a video unit to display video can be separated from a main body of a portable AV player whenever a user desires. Accordingly, since the user can carry and use the main body without the video unit when audio reproduction is desired, a size of the AV player, which is an important aspect of a portable device, can be minimized, thereby increasing portability. Additionally, the main body, which includes an audio unit to reproduce audio, can be used for a maximum amount of time under a limited power supply, since only components in the main body are driven and components in the video unit are not driven.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A portable audio/video (AV) player, comprising:
a main body to generate video data and audio data by decoding a compressed file, and to reproduce the generated audio data; and
a video unit detachably connected to the main body and to display the generated video data when combined with the main body.

2. The portable AV player of claim 1, further comprising:
a storage medium disposed in the main body to store the compressed file.

3. The portable AV player of claim 2, wherein the main body compresses an audio signal input from an external device and stores the compressed audio file in the storage medium.

4. A portable audio/video (AV) player comprising:
a main body to reproduce audio data generated by decoding a compressed file; and
a video unit detachably connected to the main body and to display video data generated by decoding the compressed file when combined with the main body.

5. The portable AV player of claim 4, further comprising:
at least one storage medium disposed in at least one of the main body and the video unit to store the compressed file.

6. The portable AV player of claim 5, wherein the main body compresses an audio signal input from an external device and stores a corresponding compressed audio file in the at least one storage medium.

7. A portable audio/video (AV) player, comprising:
a main body including an AV codec unit to generate video and audio data by decoding a compressed file, an audio processing unit to reproduce the audio data, and a controller to control the AV codec unit and the audio processing unit; and
a video unit detachably connected to the main body and to display the video data transmitted from the main body when combined with the main body.

8. The portable AV player of claim 7, further comprising:
a storage medium disposed in the main body to store the compressed file.

9. The portable AV player of claim 8, wherein the storage medium is one of a flash memory and a hard disk drive (HDD).

10. The portable AV player of claim 8, wherein the main body further comprises:
a communication interface unit to provide a communication interface with an external device, and the controller controls the communication interface unit and the storage unit to store data input through the communication interface unit in the storage unit.

11. The portable AV player of claim 8, wherein the main body further comprises:
a line amplifier to amplify an audio signal input from an external device; and
an analog-to-digital converter (ADC) to convert the amplified audio signal output from the line amplifier to digital data, and the controller controls the AV codec unit to compress the digital data output from the ADC and store the compressed digital data in the storage medium.

12. The portable AV player of claim 7, wherein the video unit further comprises:
a display unit; and
a display controller to control the display unit to display the video data.

13. A portable audio/video (AV) player, comprising:
a main body having an audio codec unit to generate audio data by decoding an audio portion of a stored compressed file, an audio processing unit to reproduce the audio data, and a controller to control the audio codec unit and the audio processing unit according to operational commands of a user; and
a video unit detachably connected to the main body to transmit and receive signals to and from the main body when the video unit is combined with the main body, the video unit including a video decoder to generate video data by decoding the stored compressed file, a second display unit, and a display controller to control the second display unit to display the video data.

14. The portable AV player of claim 13, wherein the main body further includes a key input unit to receive key input signals corresponding to the operational commands and to transmit the key input signals to the controller.

15. The portable AV player of claim 13, wherein the main body further includes a first display unit to display a processing status of the audio data.

16. The portable AV player of claim 13, wherein the main body further includes a first storage medium to store an audio signal input from an external device and compressed by the audio codec unit.

17. The portable AV player of claim 13, wherein the video unit further includes a second storage unit to store the compressed file.

18. A portable AV player, comprising:
a first unit to output an audio signal;
a second unit to output a video signal; and
a connector to detachably connect the first and second units and having first and second connecting parts disposed in the first and second units, respectively, that form an insertable card type connection such that signals are transmitted between the first and second units.

19. The portable AV player of claim 18, wherein the first and second units comprise first and second displays, respectively, such that the first display of the first unit is powered on when the first and second units are not connected, and the second display of the second unit is powered on when the first and second units are connected.

20. The portable AV player of claim 18, wherein:
the second unit comprises an auxiliary processing unit to output video data on a display in the second unit when connected to the first unit; and
the first unit comprises a main processing unit to process the video data and audio data, to output the audio data as a sound output, and to provide the video data to the second unit when the second unit is connected to the first unit.

21. The portable AV player of claim 18, wherein:
the second unit comprises a video processing unit to process a video component of an AV file when the second unit is connected to the first unit; and
the first unit comprises an audio processing unit to process an audio component of the AV file regardless of whether the first and second units are connected.

22. The portable AV player of claim 18, wherein the first unit comprises:
a controller to detect whether the first and second units are connected to each other and to output a unit detection signal indicating whether the first and second units are connected to each other.

23. The portable AV player of claim 22, wherein the first unit further comprises an AV codec unit to receive the unit detection signal from the controller, to decode audio and video data when the unit detection signal indicates that the first and second units are connected, and to decode the audio data when the unit detection signal indicates that the first and second units are disconnected from each other.

24. The portable AV player of claim 18, wherein the first unit is operable to output the audio signal when the second unit is disconnected therefrom.

25. A portable AV player, comprising:
a first unit to generate first and second portions of a multimedia file and to output the first portion of the multimedia file; and
a second unit detachably connected to the first unit to receive and output the second portion of the multimedia file when the second unit is connected to the first unit.

26. A reproduction method in a portable audio/video (AV) player, the method comprising:
reproducing, using a main body, audio data generated by decoding a stored compressed file;
receiving, in the video unit, video data generated by decoding the compressed file from the main body; and
displaying the video data using a video unit detachably connected to the main body.

27. A reproduction method in a portable audio/video (AV) player, the method comprising:
displaying, using a video unit detachably connected to a main body, video data generated by decoding a stored compressed file; and
reproducing, using the main body, audio data generated by decoding the compressed file received from the video unit.
